(19) United States
(12) Patent Application Publication
(10) Pub. No.: US 2021/0015103 A1
(43) Pub. Date: Jan. 21, 2021

(54) BIOCIDAL METAL PARTICLES, AND METHODS FOR PRODUCTION THEREOF

(71) Applicant: AEREUS TECHNOLOGIES INC., Burlington (CA)

(72) Inventor: THOMAS PORTMAN, TORONTO, ON (CA)

(21) Appl. No.: 16/797,113

(22) Filed: Feb. 21, 2020

Related U.S. Application Data
(63) Continuation of application No. 16/064,135, filed on Jun. 20, 2018, now abandoned.
(60) Provisional application No. 62/270,319, filed on Dec. 21, 2015.

(51) Int. Cl. A01N 59/20; B22F 9/08; B22F 1/00; A01N 25/28

(52) U.S. Cl. CPC A01N 59/20; B22F 9/08; B22F 1/0062; A01N 25/28; B22F 1/0059

(57) ABSTRACT

The present disclosure provides biocidal metal particles, and methods for production thereof. The method of producing the biocidal materials includes thermally spraying, into a collection system, a feed material having a metal mixture having from about 2% to about 96 wt. % Cu, about 2 to about 96 wt. % Zn, and about 1 to about 40 wt. % Ni, under conditions to give particles with a size in a range from about 1 to about 50 microns. The metal particles are collected and are characterized in that they have an amorphous solid structure and exhibit enhanced biocidal properties.

### FIELD

The present disclosure relates to a method for producing metal particles exhibiting biocidal properties and using these particles as antimicrobial additives to produce articles or films with a coating having antimicrobial properties, and articles produced by the method.

### BACKGROUND

United States Patent Publication No. 2015/0099095A1 discloses thermally sprayed alloys of for example copper which exhibit highly effective antimicrobial properties when the alloys are thermally sprayed to form a coat onto surfaces. However a problem with adapting such antimicrobial coats to many of the touch surfaces within a health care environment is the number of substrates and surfaces that need to be coated. Much work has gone into adding various antimicrobial ion agents to coatings and polymers but this approach has met with limited success as the ion activity is normally short lived. For example, in the case of silver ions being used, the silver ions must be present within a solution or contact with a human body and the antimicrobial activity is unable to last the lifetime of the products intended use. Having a long lasting inexpensive antimicrobial that could be added to everything from paints to plastics to hard and soft surfaces would be greatly advantageous in many environments.

### SUMMARY

Disclosed herein is a method of producing biocidal metal particles, comprising:

thermally spraying, into a collection system, a feed material having a metal mixture comprising about 2% to about 96 wt. % Cu, about 2 to about 96 wt. % Zn, and about 1 to about 40 wt. % Ni, under conditions to give particles with a size in a range from about 1 to about 50 microns; and collecting the sprayed metal particles, and wherein said collected sprayed metal particles are characterized in that they have an amorphous solid structure and exhibit biocidal properties.

In an embodiment, the feed material has a metal mixture comprising about 62.5 to about 66 wt. % Cu, about 16 to about 18 wt. % Zn, and about 17 to about 19 wt. % Ni.

In an embodiment, the feed material has a metal mixture comprising about 65 wt. % Cu, 17 wt. % Zn, and 18 wt. % Ni.

The feed material may include trace amounts of Iron (Fe) and Manganese (Mn) of up to about 0.5% of each.

The produced metal particles are characterized by having a composition as measured by EDX to be about 25.49 wt. % Cu, about 67.86 wt. % Zn, and about 6.66 wt. % Ni.

The produced metal particles are characterized by having a composition, as measured by elemental analysis, of about 54.7 wt. % Cu, about 34.1 wt. % Zn, and about 11.2 wt. % Ni, wherein during the elemental analysis the particles are dissolved in an acid solution and resulting metal ions are identified and quantified inductively coupled plasma emission spectroscopy (ICP).

In an embodiment the particles are produced under conditions to give particles with a size in a range from about 5 to about 10 microns.

The particles may be produced using twin arc thermal spraying, and wherein the feed material may be in a form of a wire.

In an embodiment, the metal particles exhibiting biocidal properties may be mixed with a polymer precursor to form a mixture, followed by polymerizing the polymer precursor to form a polymer containing the metal particles, and treating the polymer to expose metal particles on at least one surface of the polymer.

The polymer may be a thermoset polymer, and wherein the thermoset polymer may be any one or combination of an epoxy, phenolic resin, polyurethane, polytetrafluoroethylene, polyvinylidene fluoride, polyester thermoset, urea formaldehyde, acrylics, epoxies, silicone, alkyd polymer, urethane polymer and polyvinyl fluoride polymer.

The polymer may be a thermoplastic polymer, and the thermoplastic polymer being any one of polyurethane, polyethylene, polystyrene, polypropylene, nylon, acrylonitrile butadiene styrene, acrylonitrile styrene, ethylene vinyl acetate, methacrylic acid methyl ester, polyamide, polyacetal, polybutylenes terephthalate, polycarbonate, polyphenylene sulfide, liquid crystalpolymer, polyphenylene oxide, polysulfone, polyether sulfone, polyethylene terephthalate, polyether ether ketone, and any composites and combinations thereof.

Treating the polymer to expose the metal particles on at least one surface includes may include any one or combination of mechanically abrading the surface, chemically etching the surface, sand blasting the surface, tumbling the article, vibe bowl and thermal treatment to remove any polymer overcoating the metal particles.

Once the metal particles on at least one surface are exposed, the surface may be polished.

The metal particles may be mixed with a liquid, cream and/or emulsion.

A further understanding of the functional and advantageous aspects of the present disclosure can be realized by reference to the following detailed description and drawings.

### BRIEF DESCRIPTION OF THE DRAWINGS

Embodiments of the disclosure will now be described, by way of example only, with reference to the drawings, in which:

FIG. 1 is a schematic cross-section of a wire arc thermal spray gun.

FIG. 2 shows the setup for particle in-flight temperature measurements.

FIG. 3 shows particle in-flight temperature evolution of stainless steel sprayed by wire-arc.

FIG. 4 shows a photograph of the thermal spray gun in operation.

FIG. 5 shows in-flight temperature variation as a function of spray distance.

FIG. 6 shows and X-ray diffraction (XRD) spectrum of metal powders made according to the present disclosure showing the particles exhibit an amorphous solid structure, the metal particles being produced by thermally spraying a feed material having a composition of about 65 wt. % Cu, about 17 wt. % Zn, and about 18 wt. % Ni;

FIG. 7 shows the result of differential scanning calorimetry (DSC) on the metal particles made according to the present disclosure showing the particles exhibit an amorphous crystal structure.

FIG. 8 shows particle size distribution of the particles collected using the present method.

FIG. 9 shows particle size distribution of the particles normalized to the area coated in one study.

FIG. 10 shows the SEM images of a cross-section of a particle-polymer composite. The image on the left was taken using the backscattering mode and the image on the right was taken using the secondary electron mode.

FIG. 11 shows that after 120 minutes of exposure to a lawn of bacteria, there were no colonies detected in either the ‘low’ or ‘high’ tubes indicating complete inhibition of growth.

### DETAILED DESCRIPTION

Without limitation, the majority of the systems described herein are directed to a thermal spray system and collection of metal particles produced by the thermal spray method. A surprising property of these metal particles is that they exhibit significant biocidal properties for killing various bacteria, viruses and the like. As required, embodiments of the present disclosure are disclosed herein. However, the disclosed embodiments are merely exemplary, and it should be understood that the disclosure may be embodied in many various and alternative forms.

The figures are not to scale and some features may be exaggerated or minimized to show details of particular elements while related elements may have been eliminated to prevent obscuring novel aspects. Therefore, specific structural and functional details disclosed herein are not to be interpreted as limiting but merely as a basis for the claims and as a representative basis for teaching one skilled in the art to variously employ the present disclosure. For purposes of teaching and not limitation, the illustrated embodiments are directed to a method of producing biocidal metal particles, and articles of manufacture produced using these particles.

As used herein, the term “about”, when used in conjunction with ranges of dimensions, velocities, temperatures or other physical properties or characteristics is meant to cover slight variations that may exist in the upper and lower limits of the ranges of dimensions as to not exclude embodiments where on average most of the dimensions are satisfied but where statistically dimensions may exist outside this region. For example, in embodiments of the present disclosure dimensions of components of a thermal spray system are given but it will be understood that these are non-limiting.

As used herein the term “polymer” means any thermoset polymer, any thermoplastic polymer, any plastic and rubber.

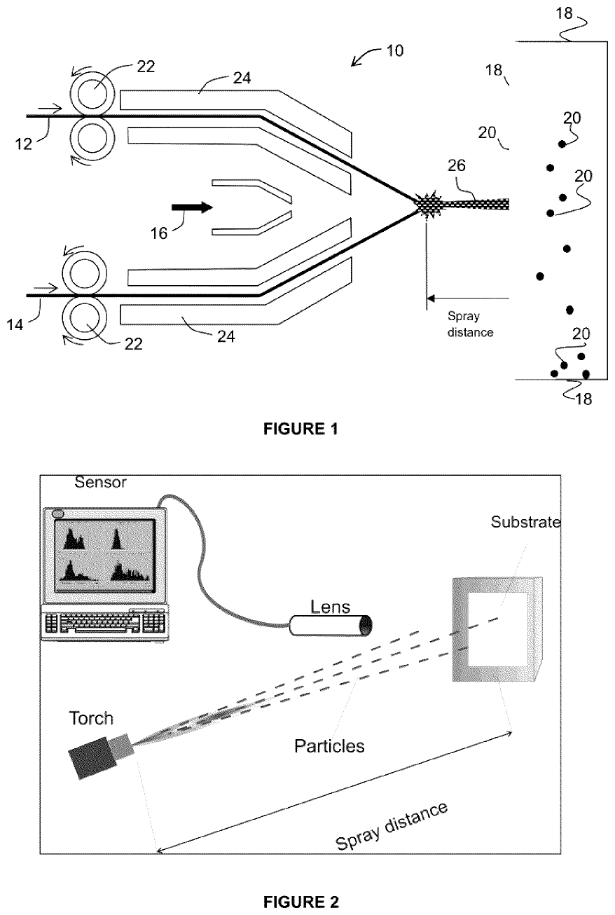

In an embodiment, metal droplets are collected via an electric arc wire spray process. A functional schematic of the process is shown in FIG. 1 which illustrates a wire arc spray gun generally at 10 configured for twin arc thermal spray deposition. During the metal droplet production process, a large voltage is applied between two metallic wires 12 and 14 such that high currents flow between the wires 12 and 14. Compressed air 16 atomizes the molten material and accelerates the metal into a jet 26 which produces metal “dust” particles 20 which are collected in a collection system or plenum 18. The wires 12 and 14 are fed using rollers 22 and guided by wire guides 24.

The particle temperature may be measured optically by two-color pyrometry to determine an optimal spray distance depending on melting point of the sprayed metal, as shown in FIG. 2. Among systems for in-flight particle temperature measurements available on the market, DPV-2000 and Accuraspray are well-established systems manufactured by TECNAR Automation Ltd., St-Bruno, Qc, Canada.

It will be appreciated by those skilled in the art that many other methods of thermal spray deposition may be used and it is understood that the present disclosure is not restricted to the use of the twin arc spray process to produce the metal droplets, although it is the most cost effective and robust process and thus is a preferred embodiment. Other types of thermal spray such as flame spray, plasma spray, high-velocity oxygen-fuel spray, kinetic or cold spray, may be used in place of the wire arc spray gun 10 of FIG. 1 to produce and collect rapidly cooled glassy metal particles or in the case of HVO spray or cold spray rapidly impacted alloys creating similar non uniform crystallinity.

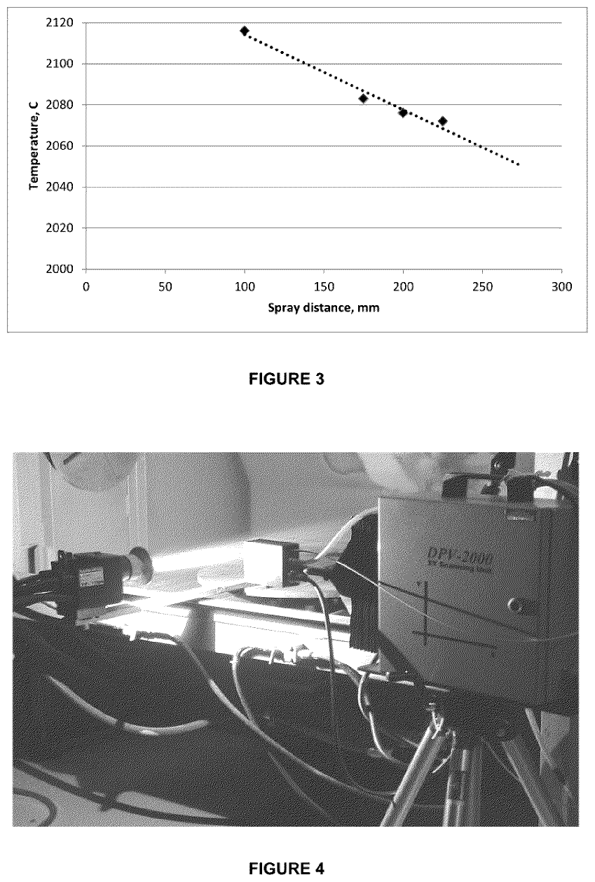

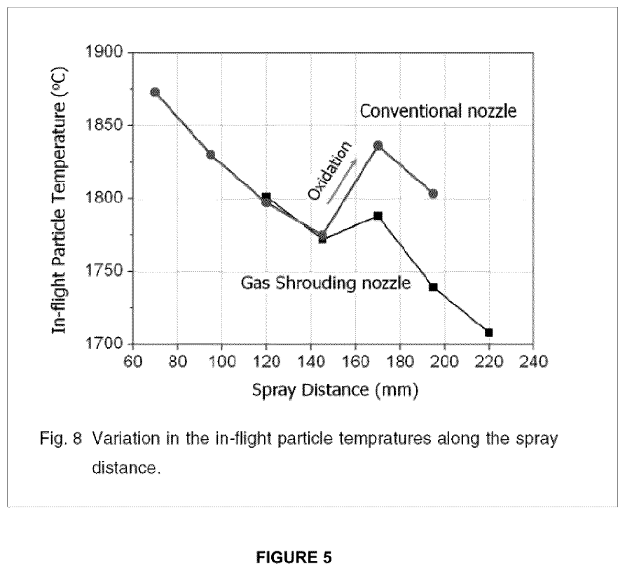

For the collection of the metal particles, in-flight particle conditions such as temperature, velocity, size and number of particles are measured for the particular metal being deposited along the centerline of the particulate plume by a sensor at various spray distances. Since particles in-flight are cooled by ambient air, substantially all particles will solidify after travelling a certain distance. Based on these measurements one can determine at what distance from the surface of the substrate or plenum being applied the particle temperature is close to its melting point but are not yet solidified and are still in a molten phase. As a result, a set of spray parameters such as spray distance and torch input power for specific metallic materials can be established. This set of parameters will allow the metal particles to be collected in plenum 18. The parameters are chosen to produce the metal particles with a sizes in a selected size range. The data shown in FIG. 3 obtained by the inventors show examples of particle temperature evolution during flight, in which temperature is plotted as a function of spray distance for stainless steel particles during wire-arc spray. The plot illustrates the inverse relationship between spray distance and mean particle temperature.

Broadly, present method of producing biocidal amorphous metal particles includes thermally spraying, into a collection system, a feed material having a metal mixture comprising about 2% to about 96 wt. % Cu, about 2 to about 96 wt. % Zn, and about 1 to about 40 wt. % Ni. The feed material is thermally sprayed under conditions to give particles with a size in a range from about 1 to about 50 microns. The metal particles are collected and may be subject to a screening or filtering step to remove particles greater than 50 microns. As noted above, using a mixed metal feed material with Copper (Cu), Zinc (Zn) and Nickel (Ni) in the aforementioned ranges provides metal particles characterized in that they exhibit biocidal properties, as will be described by way of example hereinafter.

For the metal mixture feed material disclosed herein the spray distance was from about 270 to 300 mm. The spray distance is defined as a distance from nozzle or tip of the spray gun to the substrate or plenum.

In order to maintain the rapid cooling of the particles cooling can be provided, for example, by air jets directed to the spray area. The air flow rate will depend on several parameters including the distance of the air nozzle from the substrate surface or plenum FIG. 4, nozzle diameter, deposition rate and metal thermal properties. For instance, inventor calculations show that for an air jet with a 25 mm diameter placed at a distance of 50 mm from the surface when the spraying rate is approximately 54 g/min, the air flow should be somewhere between 50 to 250 1/min. The higher the flow rate, the more effective the cooling of the substrate and particles will be.

Without being limited by any theory, it is believed that there is a direct correlation between the resulting crystallinity of the sprayed metal alloy particles and the degree to which the molten particles cool and in this regard improved biocidal efficacy with the amorphous structure.

Studies by the inventors have shown that particle velocity is also a useful parameter in producing the biocidal metal particles. The inventor's studies of the wire-arc process show that the metal particles acceleration continues to distances 170-200 mm depending on the process parameters, primarily on atomizing gas flow rate and the metal density. At longer spray distances for collection of particles velocities may be adjusted by increasing of atomizing gas flow rate or using spray guns which provide higher particle velocities.

In present studies, biocidal metal particles were collected by means of a non-limiting exemplary dry dust collection plenum system 18 in which the thermally sprayed metal feed material is sprayed into the dry dust collector plenum from a distance of 12″ to 24″ from the nozzle of the twin arc gun to plenum, which then leads through 20 to 50 feet of 12″ duct for rapid cooling of particles in a dry dust collector. The particle-laden gases enter through a side intake of the dust collector's hopper, under vacuum or pressure. The gases are then filtered through cartridges and exit through the venturi into the clean air plenum. The clean air can either be channeled outside or re-circulated depending on the application. The metal particles are then deposited into a 50 gallon drum for processing to separate particles to give the metal particles in the desired micron sizes.

Particles with sizes from about 1 micron to about 50 microns represent a broad range and a preferred range of particle sizes is from about 5 microns to about 10 microns. As will be discussed in the Examples hereinafter, the metal particles themselves exhibit very high efficacy as biocidal agents. In addition, when in incorporated into other materials articles of manufacture can be produced having biocidal properties. The biocidal metal particles produced in accordance with the present disclosure may be incorporated into any material amenable to being produced in a way that can incorporate the metal particles. Such materials include, but are not limited to, polymers, plastics, rubbers, and any liquids, creams and emulsions to mention just a few.

Non-limiting examples of making articles of manufacture include mixing the metal particles exhibiting biocidal properties with a polymer precursor to form a mixture, polymerizing the polymer precursor to form a polymer containing the metal particles, and treating the polymer to expose metal particles on at least one surface of the polymer. Once polymerized at least one surface (or more) are treated to give a polymer product with a surface having metal particles at least partially exposed to provide a biocidal polymer based product.

In an example, in the case of injection molding, the inner surfaces of the mold may be sprayed with a solution containing the amorphous metal particles such that when a polymer material is extruded, the powders come of the inner surface of the mold and are embedded in the surfaces of the molded article whereupon they can be exposed by any one of several methods discussed herein.

The polymer may be any one or combination of acrylics, epoxies, silicone, alkyd polymers, urethane polymers and polyvinyl fluoride polymers.

The polymer may be a thermoplastic polymer, with the thermoplastic polymer being any one of polyurethane, polyethylene, polystyrene, polypropylene, nylon, acrylonitrile butadiene styrene, acrylonitrile styrene, ethylene vinyl acetate, methacrylic acid methyl ester, polyamide, polyacetal, polybutylenes terephthalate, polycarbonate, polyphenylene sulfide, liquid crystalpolymer, polyphenylene oxide, polysulfone, polyether sulfone, polyethylene terephthalate, polyether ether ketone, and any composites and combinations thereof.

The polymer may be a thermoset polymer, with the thermoset polymer being any one of an epoxy, phenolic resins, polyurethane, polytetrafluoroethylene, polyvinylidene fluoride, polyester thermosets, urea formaldehyde and any composites and combinations thereof.

The polymer encapsulating the metal particles may be treated to partially expose the metal particles at one or more surfaces of the object. This treatment may include any one or combination of mechanically abrading the surface, chemically etching the surface, sand blasting the surface, tumbling the article, vibe bowl to give a vibratory finishing, as well as by thermal treatment to remove any polymer overcoating the metal particles. Once the surface(s) have been treated, the article may be polished on the exposed surfaces.

When a rubberized article is produced, the metal particles exhibiting biocidal properties with a liquid rubber precursor to form a mixture are mixed with a liquid rubber precursor which is then cured to form a rubberized article of manufacture, treating at least once surface of the article to partially expose metal particles.

Acrylic coatings are available in air drying or thermosetting compositions, acrylics are relatively high cost materials. Epoxy coatings have excellent resistance to wear and chemicals. They are relatively expensive and are only available in thermosetting or two part (catalyst activated) compositions with relatively short pot lives. They are good for severe indoor applications, but can degrade rapidly and darken in a few months of exterior service.

Silicone coatings provide the best potential for coatings which must operate at elevated temperatures. Ultraviolet absorbing compounds can be added to prevent darkening of the silicone during exterior exposures.

Alkyd coatings are slow drying and baking is required when applying the alkyd coatings.

Urethane coatings may be used but color degradation on exterior exposure has been a problem with urethane coatings.

Polyvinyl fluoride films (Tedlar) may be applied by roll bonding with an adhesive. Tedlar films have been used to protect sheet copper in exterior applications.

### Characterization of the Metal Particles Procedure

A mixed metal feed material was used to produce metal particles for study of the chemical, physical and biocidal of the produced metal particles.

The mixed metal feed material comprised about 65 wt. % Cu, about 17 wt. % Zn, and about 18 wt. % Ni. It will be appreciated that the alloys of the mixed metal feed material may include trace amounts of other materials, for example trace amounts of Iron (Fe) and Manganese (Mn) of about 0.5% each were detected in the starting alloy.

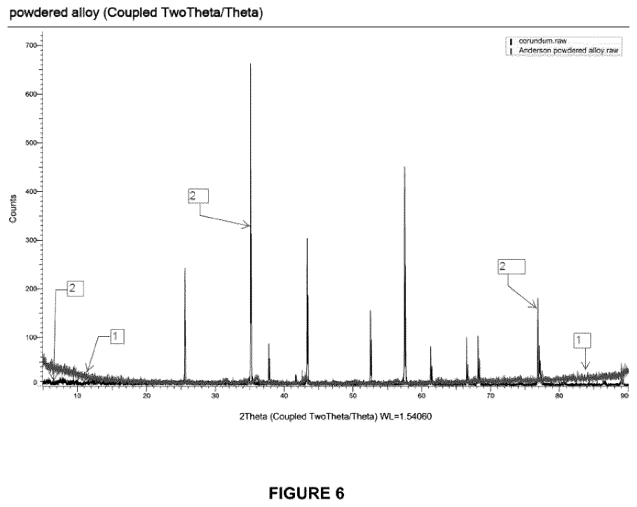

FIG. 6 shows and X-ray diffraction (XRD) spectrum of metal powders made according to the present disclosure showing the particles exhibit an amorphous solid structure. The X-ray diffraction result, from the powder diffractometer, show the results of the produced particles sample (line 1). Line 2 is the X-ray diffraction spectra of a corundum standard that is used to ensure that the XRD is working properly. The line 1 powder results of the produced particles show no significant peaks, indicating that there is no regular crystalline structure to the material. Since it is known that a typical crystalline or at least partially crystalline metal alloy should have at least some peaks, it can therefore be concluded that the particles produced using the method disclosed herein produces amorphous metal particles (or a metallic glass).

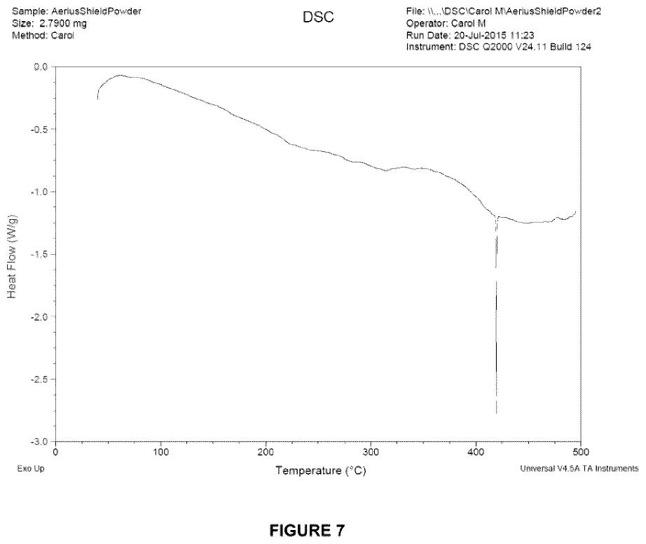

Further studies were conducted to ascertain the crystallinity of the metal particles. FIG. 7 shows the result of differential scanning calorimetry (DSC) of the thermally sprayed metal particles where the powder was slowly heated up and the rate of heat input was monitored. The negative peak at about 420° C. is indicative of a structural relaxation occurring around that temperature. With metallic glasses, this structural relaxation is expected to occur at some elevated temperature where the atoms have enough mobility to re-arrange themselves into a material with more crystalline structure (since metallic glasses are thermodynamically unstable and will revert to a crystalline material given enough time/temperature). Therefore, this data is further evidence of the metallic glass nature of the powder particles.

### Characterization of Size Distribution and Material Composition

In order to characterize the size distribution and material composition of the metal dust particles and their distributions in polymer composites, we have prepared samples of the particles alone and samples of particle-epoxy composites and analyzed these samples by Scanning Electron Microscope (SEM) and Energy-dispersive X-ray spectroscopy (EDX), Zeiss Leo 1530 at Waterloo Advanced Technology Laboratory (WATLAB).

More particularly, all collected metal particles were cleaned with water and ethanol before use. The pure metal particle samples were prepared by adhering the particles with double-sided conductive tapes on SEM stubs. The particle-epoxy composite samples were prepared by mixing 20 wt. % metal particles in epoxy solution, which is composed of D.E.R 331 Epoxy Resin and D.E.H. 24 Curing Agent at 100:13 weight ratio, depositing a drop of the mixture on SEM stubs, and curing the mixture at 150° C. for 90 minutes. As metal particles tend to be covered by polymers in a metal-polymer composite due to the difference in surface energies, some of the composite samples were roughened by sand paper to remove their surface layers and reveal their bulk cross-sections. All samples were coated with a 10 nm layer of gold by vacuum deposition to enhance conductivity before analyzing with SEM. The images of the samples from SEM were processed with a commercial software, SPIP 6.5, in order to determine the distribution of particle size and other properties.

### Results

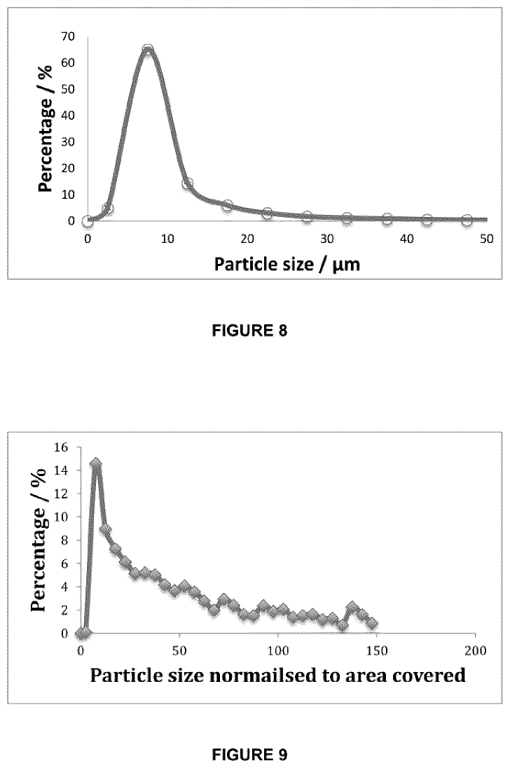

The size distribution of the thermally sprayed metal particles from the SEMs of the pure metal particle samples is shown in FIG. 8 and the distribution normalized by the area covered by each particle is shown in FIG. 9. The particle sizes relative to the area covered by the particles was calculate using the equation given below:

$$\frac{Area covered by particle}{Total are covered by all the particles} \times 100 \%$$

Error bars are not visible in the plots as the standard deviations are very small. The result indicates that the vast majority (>90%) of the particles are in the range between 5 to 10 pm in diameter. However, in terms of area, these particles only occupy around 25% of the total area, where the most of the remaining areas (˜50%) are covered by particles in the range between 10 to 50 μm. There a few larger granular metal pieces which are likely compacted clumps or agglomerations of the fine powder material.

Concurrently with these SEM measurements, the composition of these pure metal particles was measured by EDX to be 25.49 wt. % Copper (Cu), 67.86 wt. % Zinc (Zn), and 6.66 wt. % Nickel (Ni). This is very different from the composition of the raw metal feed material of the thermo-spraying process (where the composition of the feed is about 65 wt. % Cu, 17 wt. % Zn, and 18 wt. % Ni). As EDX detects the composition of materials with a penetration depth about 2 microns, which is smaller than the typical size of the metal particles, this difference in composition is likely because the surface and the bulk composition of the dust particles are different. In addition, the EDX measurement is looking at local point surfaces and may not be representative of the overall bulk sample. This variation between the surface and the bulk of the dust particle could be a result of the rapid cooling from the thermal spraying process. When the metal particles are measured by elemental analysis, where the particles are dissolved in acid and the resulting ions are identified, and quantified using inductively coupled plasma emission spectroscopy (ICP), the composition of the metal particles was determined to be 54.7% Cu, 34.1% Zn, and 11.2% Ni, which is closer to the raw feed material of 65 wt. % Cu, 17 wt. % Zn, and 18 wt. % Ni than observed from the EDX measurements.

For the composite samples, the surface was completely covered by epoxy, with no dust particles visible in SEM. However, once we removed a surface layer of the sample by roughening, the cross-section of the composite revealed that the metal particles covered approximately 0.396±0.034% of the cross-sectional area.

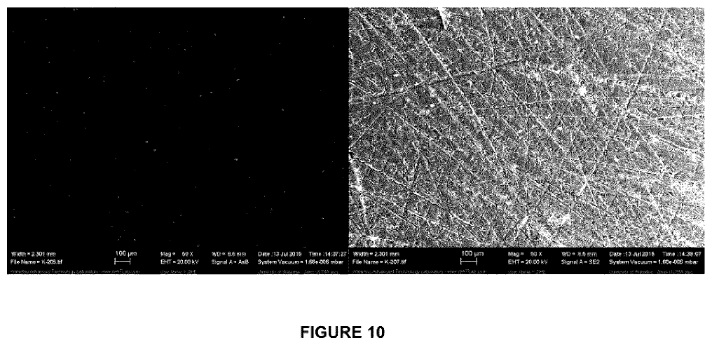

FIG. 10 shows the SEM images of a cross-section of a particle-polymer composite with the backscattering mode on the left and the secondary electron mode on the right. When using the backscattering mode, the metal particles appeared brighter than the epoxy polymers due to fact that the metal particles contain heavier elements (high atomic number) than that of the epoxy. As a result, the white spots in the backscattering image are metal particles exposed at the cross-section and the area of coverage of the particles is determined according to the image.

A variety of example studies, presented below, have been carried out to examine characteristics of products obtained using methods of the disclosure, which can aid in optimizing parameters to obtain a suitable particle size and composition for its intended use.

### EXAMPLE 1

### Evaluation of Bacterial Growth Inhibiting Activity of Thermally Sprayed Metal Particles by Themselves

### Material Methods and Materials

Twenty millilitres of Luria Broth (LB) media was inoculated with DH5o strain of Escherichia coli (E. coli) and was placed in a 37° C. shaking incubator for 6 hours in a 50 mL Falcon tube. The tube was removed from the incubator and the optical density 600 (OD600) of the culture was measured to be 2.3. A 1g aliquot of the metal dust particles were added to each of two 50 mL Falcon tubes for parallel ‘high’ (3 mL) and a ‘low’ (1 mL) bacteria assay. Luria Broth (LB) media was added to each of the two Falcon tubes containing the metal dust particles (17 mL in the ‘High’ tube and 19 mL in the ‘Low’ tube).

The tubes were capped and inverted to form a colloidal solution of the metal dust particles. An aliquot of the bacteria was added to each tube (3 mL for ‘high’ and 1 mL for ‘low’ for a 20 mL final volume) containing the colloidal mixture of metal dust particles and the tubes were immediately capped and mixed by repeated inversion. Aliquots of 200uL of the re-suspended colloidal mixture were plated onto LB agar plates and at the following times after the addition of bacteria: 0 min. (removed after addition of the bacteria), 15 min., 60 min., 120 min. During the time-course, the tubes were shaken horizontally on a rotary platform shaker at room temperature at 60 rpm. At each time-point the tubes were put vertically in a rack for 3 minutes before the removal of the 200 uL aliquot of material for plating to allow for the colloid to settle slightly from the liquid. After the time-course had been completed, all plated were transferred to a 37° C. incubator overnight. The following day the plates were observed for bacterial growth.

### Results and Discussion

The metal particles appeared to have little if any solubility in aqueous solutions. However rigorous solubility assays were not part of this study. The majority of the material did settle quickly to the bottom of the tube in a 20 mL volume (˜3 minutes) although some material did not settle as the liquid remained translucent. During the experiment, it was decided to allow for the tubes to rest vertically before removal of aliquots for testing in order to decrease the amount of the metal dust colloidal mixture being transferred to the LB agar plates, where the metal dust particles might have growth inhibiting activity that is outside of the scope of the present study. It was decided not to centrifuge the tubes during collection of these aliquots to remove colloid because that process would likely pellet the bacteria leading to artificially low colony numbers.

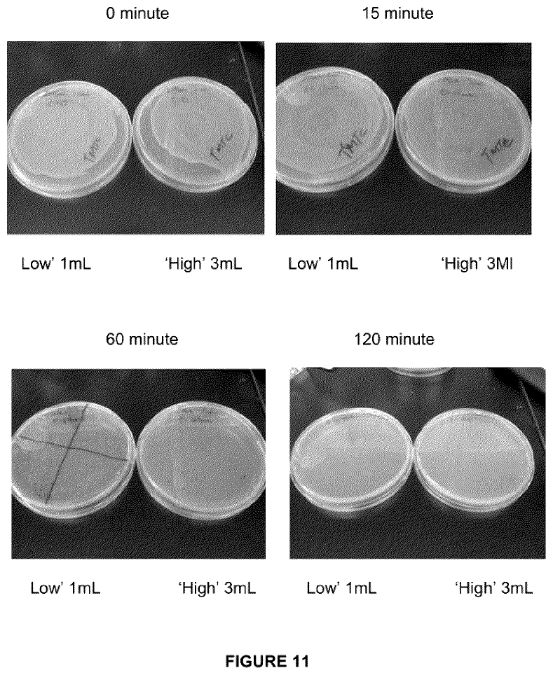

FIG. 11 shows photographs of the agar plates used in the study. The original culture of bacteria and the 0 minute time point appear to have similar amounts of bacteria, although both time points produced a lawn of bacteria. After 15 minutes, the ‘low’ tube appeared to have a smaller amount of growth as colonies were becoming evident although the numbers were still too high to count. The ‘High’ tube after 15 minutes till produced a lawn of bacteria indicating the bacterial load used was excessive for this time-point. After 60 minutes however, the colony numbers from both the ‘low’ tube and the ‘high’ tube were drastically reduced and are in the range appropriate for automated colony counting instrumentation. After 120 minutes, there were no colonies detected in either the ‘low’ or ‘high’ tubes indicating complete inhibition of growth. Growth of the bacteria without the metal dust particles treatment was not impeded.

In conclusion, the metal particles produced in accordance with the present disclosure show remarkable bacteria-growth inhibitory activity on their own and have been observed to exhibit bactericidal activity as well as biocidal activity in general. It is likely however that the observed inhibition of growth is bactericidal as the colloidal structures were allowed to settle from the liquid before transfer to the LB-agar plates, and growth inhibition on the plates would have also been apparent in the 0 minutes time-point.

In other experiments with aluminum alloys, brass, and copper powders by themselves, it was observed over a period of 120 minutes that there was no bacteria-growth inhibitory activity suggesting these metal particles exhibited no efficacy as biocidal agents, whereas the mixed metal Cu, Zn, Ni, powders disclosed herein showed remarkable bactericidal activity showing complete colony forming unit (CFU) reduction.

In conclusion, the present metal particles based on Cu, Zn and Ni show remarkable bacteria-growth inhibitory activity and bactericidal activity whereas none of the above mentioned particles of thermally sprayed aluminum alloys, brass and copper exhibited no effect on bacterial growth.

### EXAMPLE 2

### Evaluation of Bacterial Growth Inhibiting Activity of Polymer/Thermally Sprayed Metal Particles Composite Materials

A mixture of 5 wt % particles with Plascoat PPA 571 ES polymer coating was prepared and applied to a metal surface to form a coating. The antimicrobial activity of this coating was compared to the same polymer coating without the particles (control surface), in the following manner.

An aqueous suspension of live E. coli bacteria was prepared with at a concentration of 1.2×10⁹ colony forming units (cfu) per mL, including 5% fetal bovine serum and 0.01% Triton X-100 to simulate the effects of a soiled surface. To 6.25 cm² of each polymer-coated surface was applied 20 μL of this suspension, and it was allowed to stand for 30 minutes. Subsequently, the surface was washed with 5 mL of phosphate buffered saline and 100 μL of this washing solution was plated on standard plate count agar and incubated at 35° C. for 48 hours. The number of colony forming units was counted for each sample.

In comparison to the control surface (i.e. polymer coating without particles), the 5% particle laden surface reduced the viable bacterial count by 4.9×10⁵ cfu/cm² in 30 minutes of exposure time, corresponding to a 0.3 log reduction. This demonstrates that the particle-polymer mixture had a significant intrinsic biocidal activity due to the presence of the amorphous solid particles contained in the mixture.

As used herein, the terms “comprises”, “comprising”, “includes” and “including” are to be construed as being inclusive and open ended, and not exclusive. Specifically, when used in this specification including claims, the terms “comprises”, “comprising”, “includes” and “including” and variations thereof mean the specified features, steps or components are included. These terms are not to be interpreted to exclude the presence of other features, steps or components.

The foregoing description of the preferred embodiments of the disclosure has been presented to illustrate the principles of the disclosure and not to limit the disclosure to the particular embodiment illustrated. It is intended that the scope of the disclosure be defined by all of the embodiments encompassed within the following claims and their equivalents.

1. A method of producing biocidal metal particles, comprising:
thermally spraying, into a collection system, a feed material having a metal mixture comprising about 2% to about 96 wt. % Cu, about 2 to about 96 wt. % Zn, and about 1 to about 40 wt. % Ni, under conditions to give particles with a size in a range from about 1 to about 50 microns;
collecting the sprayed metal particles, and
separating the sprayed metal particles from the collection system, wherein said metal particles separated from the collection system are characterized in that they have an amorphous solid structure and exhibit biocidal properties.

2. The method according to claim 1, wherein the feed material has a metal mixture comprising about 62.5 to about 66 wt. % Cu, about 16 to about 18 wt. % Zn, and about 17 to about 19 wt. % Ni.

3. The method according to claim 1, wherein the feed material has a metal mixture comprising about 65 wt. % Cu, 17 wt. % Zn, and 18 wt. % Ni.

4. The method according to claim 3, including trace amounts of Iron (Fe) and Manganese (Mn) of up to about 0.5% of each.

5. The method according to claim 3, wherein the produced metal particles are characterized by having a composition as measured by EDX to be about 25.49 wt. % Cu, about 67.86 wt. % Zn, and about 6.66 wt. % Ni.

6. The method according to claim 3, wherein the produced metal particles are characterized by having a composition, as measured by elemental analysis, of about 54.7 wt. % Cu, about 34.1 wt. % Zn, and about 11.2 wt. % Ni, wherein during said elemental analysis said particles are dissolved in an acid solution and resulting metal ions are identified and quantified inductively coupled plasma emission spectroscopy (ICP).

7. The method according to claim 1, wherein the particles are produced under conditions to give particles with a size in a range from about 5 to about 10 microns.

8. The method according to claim 1, wherein the step of thermally spraying is conducted using twin arc thermal spraying, and wherein the feed material is in a form of a wire.

9. The method according to claim 1, including mixing the metal particles exhibiting biocidal properties with a polymer precursor to form a mixture, polymerizing the polymer precursor to form a polymer containing the metal particles, and treating the polymer to expose metal particles on at least one surface of the polymer.

10. The method according to claim 9, wherein the polymer is a thermoset polymer, and wherein the thermoset polymer being any one or combination of an epoxy, phenolic resin, polyurethane, polytetrafluoroethylene, polyvinylidene fluoride, polyester thermoset, urea formaldehyde, acrylics, epoxies, silicone, alkyd polymer, urethane polymer and polyvinyl fluoride polymer.

11. The method according to claim 9, wherein the polymer is a thermoplastic polymer, said thermoplastic polymer being any one of polyurethane, polyethylene, polystyrene, polypropylene, nylon, acrylonitrile butadiene styrene, acrylonitrile styrene, ethylene vinyl acetate, methacrylic acid methyl ester, polyamide, polyacetal, polybutylenes terephthalate, polycarbonate, polyphenylene sulfide, liquid crystalpolymer, polyphenylene oxide, polysulfone, polyether sulfone, polyethylene terephthalate, polyether ether ketone, and any composites and combinations thereof.

12. The method according to claim 9, wherein treating the polymer to expose the metal particles on at least one surface includes any one or combination of mechanically abrading the surface, chemically etching the surface, sand blasting the surface, tumbling the article, vibe bowl and thermal treatment to remove any polymer overcoating the metal particles.

13. The method according to claim 12, further comprising the step of polishing the surface subsequent to treating the surface.

14. The method according to claim 1, including mixing the metal particles exhibiting biocidal properties with a liquid, cream or emulsion.

15-29. (canceled)

30. Thermally sprayed metal particles exhibiting biocidal properties separated from a collection system as defined in claim 1, prepared by thermally spraying a feed material having a metal mixture comprising about 2% to about 96 wt. % Cu, about 2 to about 96 wt. % Zn, and about 1 to about 40 wt. % Ni, wherein the metal particles separated from the collection system have a size in a range from about 1 to about 50 microns, and said metal particles are characterized in that they have an amorphous solid structure and exhibit biocidal properties.

31. The thermally sprayed metal particles according to claim 30 wherein the feed material has a metal mixture comprising about 62.5 to about 66 wt. % Cu, about 16 to about 18 wt. % Zn, and about 17 to about 19 wt. % Ni.

32. The thermally sprayed metal particles according to claim 30 wherein the produced metal particles have a composition of about 25 to about 55 wt. % Cu, about 34 to about 68 wt. % Zn, and about 6.6 to about 11 wt. % Ni.

33. The thermally sprayed metal particles according to claim 30 wherein the produced metal particles are characterized by having a composition, as measured by elemental analysis, of about 54.7 wt. % Cu, about 34.1 wt. % Zn, and about 11.2 wt. % Ni, wherein during said elemental analysis said particles are dissolved in an acid solution and resulting metal ions are identified and quantified.

34. The thermally sprayed metal particles according to claim 30 wherein the produced metal particles are characterized by having a composition as measured by EDX to be about 25.49 wt. % Cu, about 67.86 wt. % Zn, and about 6.66 wt. % Ni.

35. The thermally sprayed metal particles according to claim 30 wherein the particles are produced under conditions to give particles with a size in a range from about 5 to about 10 microns.

36. An article of manufacture, comprising a material incorporating therein the metal particles according to claim 30.

37. The article of manufacture according to claim 36, wherein the material is any one of a liquid, cream and emulsion.

38. The article of manufacture according to claim 36, wherein the material is a wound dressing having a surface configured to be contacted to a wound area, the metal particles being embedded in said surface.

39. The article of manufacture according to claim 36, wherein the material is a solid material, and wherein at least one surface of the solid material includes exposed metal particles.

40. The article of manufacture according to claim 39, wherein the solid material is a polymer.

41. The article of manufacture according to claim 40, wherein the polymer is a thermoset polymer, and wherein the thermoset polymer being any one or combination of an epoxy, phenolic resin, polyurethane, polytetrafluoroethylene, polyvinylidene fluoride, polyester thermoset, urea formaldehyde, acrylics, epoxies, silicone, alkyd polymer, urethane polymer and polyvinyl fluoride polymer.

42. The article of manufacture according to claim 40, wherein the polymer is a thermoplastic polymer, said thermoplastic polymer being any one of polyurethane, polyethylene, polystyrene, polypropylene, nylon, acrylonitrile butadiene styrene, acrylonitrile styrene, ethylene vinyl acetate, methacrylic acid methyl ester, polyamide, polyacetal, polybutylenes terephthalate, polycarbonate, polyphenylene sulfide, liquid crystal polymer, polyphenylene oxide, polysulfone, polyether sulfone, polyethylene terephthalate and polyether ether ketone, or composites or combinations of one or more of said polymers.

43. The article of manufacture according to claim 40, wherein the polymer is a thermoset polymer, said thermoset polymer being any one of an epoxy, phenolic resins, polyurethane, polytetrafluoroethylene, polyvinylidene fluoride, polyester thermosets and urea formaldehyde,or composites or combinations of one or more of said polymers.

44. The article of manufacture according to claim 41, including treating one or more surfaces of the article to expose the metal particles on at least one surface by any one or combination of mechanically abrading the surface, chemically etching the surface, sand blasting the surface, tumbling the article, vibratory bowl, and thermal treatment to partially remove the polymer at the surface of the article to expose the metal particles.

45. The article of manufacture according to claim 44, further comprising the step of polishing the surface subsequent to treating the surface.
